(19) United States
(12) Patent Application Publication
(10) Pub. No.: US 2011/0320629 A1
(43) Pub. Date: Dec. 29, 2011

(54) STREAM MEDIA SERVER, CLIENT TERMINAL AND METHOD AND SYSTEM FOR DOWNLOADING STREAM MEDIA

(75) Inventor: Mingxing Wu, Shenzhen City (CN)

(73) Assignee: ZTE Corporation, Shenzhen City (CN)

(21) Appl. No.: 13/141,416

(22) PCT Filed: Sep. 10, 2009
(86) PCT No.: PCT/CN2009/073863

§ 371 Date: Jun. 22, 2011

(30) Foreign Application Priority Data
Dec. 29, 2008 (CN) 200810246897.0

(51) Int. Cl. G06F 15/16

(52) U.S. Cl. 709/231

(57) ABSTRACT

The present invention discloses a streaming media server, a client terminal and method and system for downloading streaming media. The method comprises: receiving and caching streaming media data carried by RTP packets through a streaming media session; sorting and framing the cached RTP packets; and generating a file, writing framed data frames into the generated file. A system for downloading streaming media disclosed by the present invention at the same time comprises: a streaming media server, a client terminal, wherein the streaming media server is used for transmitting streaming media data carried by RTP packets through streaming media sessions; the client terminal is used for receiving and caching the RTP packets, sorting and framing the cached RTP packets, and generating a file, writing framed data frame in the generated file. With the present invention, the streaming media data which have already been downloaded can be displayed normally after downloading interruption.

### TECHNICAL FIELD

The present invention relates to multimedia storage technology, and in particular, to a streaming media server, a client terminal, and a method and system for downloading streaming media.

### BACKGROUND ART

A streaming media system is a typical system of a client terminal and a serving terminal, and a serving terminal is generally a streaming media server. A streaming media system supports streaming media services such as video on demand and live broadcast services, and a user can also download a streaming media source file using File Transfer Protocol (FTP), Hyper Text Transfer Protocol (HTTP) and the like when necessary.

However, loading streaming media content using FTP, HTTP and the like has the following drawbacks: streaming media content can only be downloaded with the aid of support of a server such as a FTP server and a HTTP server; it only supports download of the entire streaming media content and cannot meet a user's demand for only downloading the part of the streaming media content in which he is interested; a file cannot be displayed if it is not completely downloaded, i.e., the streaming media data that have already been stored in the file cannot be displayed normally when downloading is interrupted.

### SUMMARY OF THE INVENTION

Due to the above reasons, the main object of the present invention is to provide a streaming media server, a client terminal, and a method and system for downloading streaming media, which can ensure that the streaming media data that have already been downloaded can be normally displayed after downloading is interrupted.

In order to achieve the above object, the technical solution of the present invention is carried out as follows:

A method for downloading streaming media comprises:

receiving and caching transmitted streaming media data of a streaming media source file carried by real-time transport protocol (RTP) packets through a streaming media session;

sorting and framing the cached RTP packets; and

generating a file, writing framed data frames into the generated file.

Furthermore, the method further comprises:

storing a timestamp of a data frame that is written into the file lastly when transmission is interrupted, and discarding the cached RTP packets that have not been framed into data frames;

initiating a streaming media session establishment request by sending to a streaming media server a real-time streaming protocol describe (RTSP Describe) request carrying a URL address of a streaming media source file whose transmission is interrupted;

sending to the streaming media server a RTSP play command carrying the stored timestamp;

receiving and caching the streaming media data of the streaming media source file carried by RTP packets through the streaming media session, wherein said streaming media data are streaming media data that need to resume to be transmitted determined by the stored timestamp;

sorting and framing the cached RTP packets; and

once a data frame is framed, writing the frame of data into the file generated before transmission is interrupted.

Furthermore, the step of sorting and framing the cached RTP packets may comprise:

a. sorting the cached RTP packets;

b. searching out a first RTP packet carrying I-frame data from a sequence of RTP packets obtained by sorting; discarding RTP packets before the first RTP packet carrying I-frame data searched out in the sequence, and differentiating RTP packets carrying audio data from those carrying video data according to a PID field of a RTP packet starting from the first RTP packet carrying I-frame data that is searched out, and framing the RTP packets carrying audio and video data respectively.

Furthermore, the step of receiving and caching transmitted streaming media data of a streaming media source file carried by RTP packets through a streaming media session may comprise:

establishing the streaming media session;

sending to the streaming media server a RTSP play command carrying a starting time and an ending time of a selected portion for downloading in the streaming media source file; and

receiving and caching the RTP packets carrying the streaming media data transmitted by the streaming media server; wherein said streaming media data are streaming media data in the streaming media source file corresponding to a period from the starting time to the ending time.

Furthermore, the streaming media data that need to resume to be transmitted can be streaming media data in the streaming media source file corresponding to a period from the stored timestamp to the ending time.

The present invention also provides a client terminal, the client terminal is configured to receive and cache real-time transport protocol (RTP) packets carrying streaming media data transmitted by a streaming media server through a streaming media session; sort and frame the cached RTP packets; and generate a file and write framed data frames into the generated file; thereby achieving download of streaming media.

Furthermore, the client terminal may comprise:

a first signaling generating unit configured to have signaling interaction with the streaming media server to establish the streaming media session;

a receiving unit configured to receive and cache the RTP packets;

a processing unit configured to sort and frame the cached RTP packets; and

a first storage unit configured to generate the file and write the framed data frames into the generated file.

Furthermore, the client terminal may further comprise:

a second storage unit configured to store a timestamp of a data frame that is written into the file lastly when transmission is interrupted; and

a second signaling generating unit configured to generate and send a RTSP play command carrying the stored timestamp; and generate and send a RTSP play command carrying a starting time and an ending time of a selected portion for downloading in the streaming media source file.

The present invention also provides a streaming media server, the streaming media server is configured to transmit to a client terminal streaming media data carried by real-time transport protocol (RTP) packets through a streaming media session;

thereby the client terminal can receive and cache the RTP packets, sort and frame the cached RTP packets, generate a file and write the framed data frames into the generated file to achieve download of streaming media.

Furthermore, the streaming media server may comprise:

a first analyzing unit configured to have signaling interaction with the client terminal to establish a streaming media session; and

a transmitting module configured to obtain streaming media data required by the client terminal, transmit the obtained streaming media data to the client terminal by carrying said data with RTP packets.

Furthermore, the streaming media server may further comprise:

a second analyzing unit configured to analyze the RTSP play command carrying the stored timestamp to obtain the stored timestamp; and analyze the RTSP play command carrying a starting time and an ending time of a selected portion for downloading in the streaming media source file to obtain the starting time and ending time of a selected portion for downloading in the streaming media source file; and

a data identifying unit configured to determine streaming media data required by the client terminal to be transmitted according to the stored timestamp; and determine streaming media data required by the client terminal to be transmitted according to the starting time and ending time of a selected portion for downloading in the streaming media source file.

The present invention also provides a system for downloading streaming media, the system comprises a client terminal and a streaming media server as described above.

With the streaming media server, client terminal and method and system for downloading streaming media provided by the present invention, streaming media data are written into the file in sequence and they are not written until a frame is made, ensuring that each frame of data that is written into the file is complete and that the streaming media data that have already been downloaded can be displayed, i.e., the picture is continuous and clear, problems such as mosaic or picture interruption will not occur when downloading is interrupted. The present invention also has the following advantages and features:

1) the present invention can achieve download of a streaming media source file only through a streaming media server without any server such as a FTP server or a HTTP server;

2) in the present invention, the timestamp of the data frame that is written into the file lastly is stored after transmission is interrupted, and the streaming media data that need to resume to be transmitted are determined according to the stored timestamp and resume to be transmitted so that download of the streaming media source file can be completed by resuming transmission at the interruption point after transmission is interrupted;

3) in the present invention, the streaming media server is informed of the part of the streaming media source file in which a user is interested by setting a request time field so that the user can freely download the streaming media data of the part in the streaming media source file in which he is interested.

### BRIEF DESCRIPTION OF DRAWINGS

FIG. 1 is a flowchart for carrying out the method for downloading streaming media according to Example one of the present invention;

FIG. 2 is a flowchart for carrying out the method for downloading streaming media according to Example two of the present invention;

FIG. 3 illustrates the structure of the system for downloading streaming media according to Example three of the present invention.

### PREFERRED EMBODIMENTS OF THE INVENTION

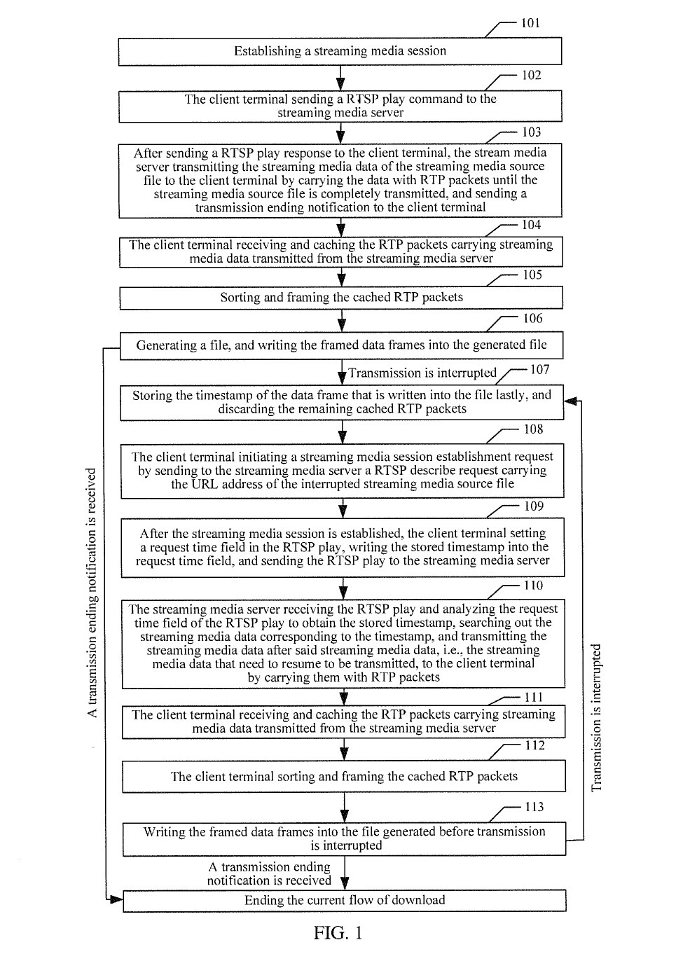

The method for downloading streaming media according to Example one of the present invention is carried out in the flowchart as shown in FIG. 1, comprising the following steps:

Step 101: a client terminal obtaining the Uniform Resource Locator (URL) address of the stream media source file to be downloaded from a streaming media server; sending to the streaming media server a real-time streaming protocol describe (RTSP Describe) request carrying the URL address; sending to the streaming media server a RTSP setup command after receiving a RTSP Describe response; completing establishment of a streaming media session after receiving a RTSP setup response. Establishment of the streaming media session complies with standard protocol requirements for RTSP.

Here, the streaming media source file can be displayed in the meantime of download, i.e., the streaming media data transmitted from the streaming media server can be displayed in the meantime of being cached, sorted, framed and written into the file without having to re-establish a streaming media session for download.

Step 102: the client terminal sending a RTSP play command to the stream media server; here, a transmission rate can also be defined by the RTSP play command, and the streaming media server is required to transmit streaming media data to the client terminal at that transmission rate.

Step 103: after sending a RTSP play response to the client terminal, the streaming media server transmitting the streaming media data of the streaming media source file to the client terminal by carrying the data with real-time transport protocol (RTP) packets until the streaming media source file is completely transmitted, and sending a transmission ending notification to the client terminal.

If transmission is not interrupted, execute steps 104-106 until a transmission ending notification is received when this flow of downloading is over, or the transmission is interrupted; if transmission is interrupted, execute steps 107-113.

Step 104: the client terminal receiving and caching the RTP packets carrying streaming media data transmitted from the streaming media server.

Wherein, the header of the RTP packet includes the following extended fields: the header of the RTP packet carrying I-frame data includes an I_frame_indicator field for indicating whether the RTP packet is the beginning, middle or ending of the I frame; a PID field for distinguishing video data from audio data; the header of the RTP packet includes a payload_unit_start_indicator field for indicating whether the RTP packet is the beginning of a frame of data.

Step 105: sorting and framing the cached RTP packets;

Said sorting and framing specifically comprises the following steps:

a. sorting the cached RTP packets; here, the purpose of sorting is to avoid disorder of transmission, which may otherwise affect framing;

b. searching out the first RTP packet carrying I-frame data from a sequence of RTP packets obtained from sorting according to the I_frame_indicator field of the RTP packets; discarding the RTP packets in the sequence before the RTP packet searched out in the sequence, and differentiating RTP packets carrying audio data from those carrying video data according to a PID field of a RTP packet starting from the RTP packet that is searched out, and framing the RTP packets carrying audio and video data respectively.

Here, said framing the RTP packets carrying audio and video data respectively specifically comprises the following steps:

searching out the RTP packet carrying video data whose payload_unit_start_indicator field is one from the sequence of RTP packets as the packet where the header of a video frame is located, framing each packet where the header of a video frame is located and the RTP packets carrying video data with removal of the header before the next packet where the header of a video frame is located into a frame in sequence;

searching out the RTP packet carrying audio data whose payload_unit_start_indicator field is one from the sequence of RTP packets as the packet where the header of an audio frame is located, framing each packet where the header of an audio frame is located and the RTP packets carrying audio data with removal of the header before the next packet where the header of an audio frame is located into a frame in sequence.

Step 106: generating a file, and writing the framed data frames into the generated file.

Step 107: after transmission is interrupted, the client terminal storing the timestamp of the data frame that is written into the file lastly, and discarding the cached RTP packets.

The streaming media data are written into the file in sequence through steps 105 and 106, and they are not written until a frame is made, ensuring that each frame of data that is written into the file is complete; step 107 ensures that when transmission is interrupted, the first frame of data stored in the file is also a plurality of complete and continuous data frames of I frame, which ensures normal display and that problems such as mosaic or picture interruption will not occur just because the first frame is not a key frame, therefore, the file can still be normally displayed after transmission is interrupted.

Step 108: the client terminal initiating a streaming media session establishment request by sending to the streaming media server a RTSP Describe request carrying the URL address of the interrupted streaming media source file.

Step 109: after the streaming media session is established, the client terminal setting a request time field in the RTSP play, writing the stored timestamp into the request time field, and sending the RTSP play to the streaming media server.

If transmission is not interrupted again, execute steps 111-113 until a transmission ending notification is received when this flow of downloading is over, or the transmission is interrupted again; if transmission is interrupted again, return to step 107 to resume transmission again and proceed with the current download task.

Step 110: the streaming media server receiving the RTSP play and analyzing the request time field of the RTSP play to obtain the timestamp stored by the client terminal, searching out the streaming media data corresponding to the timestamp, and transmitting the streaming media data after said streaming media data, i.e., the streaming media data that need to resume to be transmitted, to the client terminal by carrying them with RTP packets.

Step 111: the client terminal receiving and caching the RTP packets carrying streaming media data transmitted from the streaming media server.

Step 112: the client terminal sorting and framing the cached RTP packets; the specific steps for sorting and framing here are the same with those in step 105, and thus will not be described repeatedly here.

Step 113: writing the framed data frames into the file generated before transmission is interrupted.

In steps 107-113, after transmission is interrupted, the timestamp of the data frame that is written into the file lastly is stored, and the interruption point is searched according to the stored timestamp to determine and then resume to transmit the streaming media data that need to resume to be transmitted so that download of the streaming media source file can be completed by resuming transmission at the interruption point after transmission is interrupted.

In steps 101-113, after a streaming media session is established through signaling interaction between the client terminal and the streaming media server, the streaming media server transmits streaming media data to the client terminal, and the client terminal caches, sorts, frames the streaming media data and writes them into a file. Since the entire flow of downloading does not use protocols such as FTP and HTTP, download of streaming media is achieved without servers except the streaming media server.

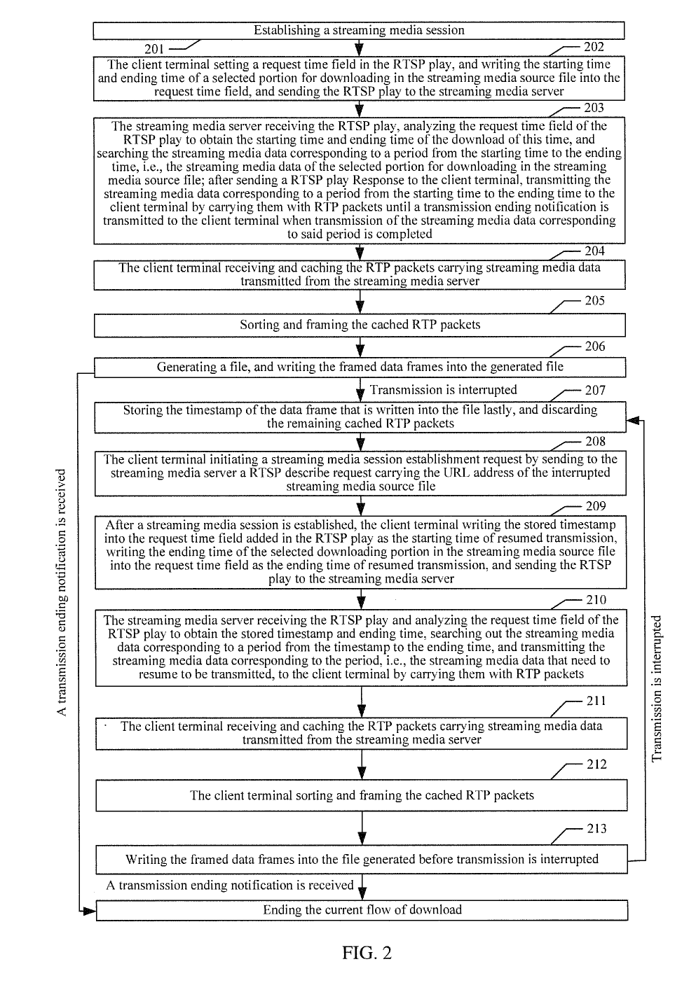

The method for downloading streaming media according to Example two of the present invention is carried out in the flowchart as shown in FIG. 2, comprising the following steps:

Step 201: a client terminal obtaining the URL address of the streaming media source file from a streaming media server; sending to the streaming media server a RTSP Describe request carrying the URL address; sending to the streaming media server a RTSP setup command after receiving a RTSP describe response; completing establishment of a streaming media session after receiving a RTSP setup response. Establishment of the streaming media session complies with standard protocol requirements for RTSP.

Step 202: the client terminal setting a request time field in the RTSP play, and writing the starting time and ending time of a selected portion for downloading in the streaming media source file into the request time field, and sending the RTSP play to the streaming media server; here, a transmission rate can also be defined by the RTSP play, and the streaming media server is required to transmit streaming media data to the client terminal at that transmission rate.

Step 203: the streaming media server receiving the RTSP play, analyzing the request time field of the RTSP play to obtain the starting time and ending time of the download of this time, and searching the streaming media data corresponding to a period from the starting time to the ending time, i.e., the streaming media data of the selected portion for downloading in the streaming media source file; after sending a RTSP play Response to the client terminal, transmitting the streaming media data corresponding to a period from the starting time to the ending time to the client terminal by carrying them with RTP packets until a transmission ending notification is transmitted to the client terminal when transmission of the streaming media data corresponding to said period is completed.

In steps 202 and 203, the streaming media server is informed of the part of the streaming media source file in which a user is interested, i.e., the selected portion for downloading in the streaming media source file, by setting a request time field, and is required to transmit the streaming media data of the selected portion for downloading, so that the user can freely download the streaming media data of the part in the streaming media source file in which he is interested.

If transmission is not interrupted, execute steps 204-206 until a transmission ending notification is received when this flow of downloading is over, or the transmission is interrupted; if transmission is interrupted, execute steps 207-213.

Step 204: the client terminal receiving and caching the RTP packets carrying streaming media data transmitted from the streaming media server.

Wherein, the header of the RTP packet includes the following extended fields: the header of the RTP packet carrying I-frame data includes an I_frame_indicator field for indicating whether the RTP packet is the beginning, middle or ending of the I frame; the header of the RTP packet carrying video data includes a video_PID field for depositing a video PID value; the header of the RTP packet carrying audio data includes an audio_PID field for depositing an audio PID value; the header of the RTP packet includes a payload_unit_start_indicator field for indicating whether the RTP packet is the beginning of a frame of data.

Step 205: sorting and framing the cached RTP packets.

Said sorting and framing specifically comprises the following steps:

a. sorting the cached RTP packets; here, the purpose of sorting is to avoid disorder of transmission, which may otherwise affect framing;

b. searching out the first RTP packet carrying I-frame data from a sequence of RTP packets obtained from sorting according to the I_frame_indicator field of the RTP packets; discarding the RTP packets in the sequence before the RTP packet searched out in the sequence, and differentiating RTP packets carrying audio data from those carrying video data according to a PID field of a RTP packet starting from the RTP packet that is searched out, and framing the RTP packets carrying audio and video data respectively.

Here, said framing the RTP packets carrying audio and video data respectively specifically comprises the following steps:

searching out the RTP packet carrying video data whose payload_unit_start_indicator field is one from the sequence of RTP packets as the packet where the header of a video frame is located, framing each packet where the header of a video frame is located and the RTP packets carrying video data before the next packet where the header of a video frame is located into a frame in sequence;

searching out the RTP packet carrying audio data whose payload_unit_start_indicator field is one from the sequence of RTP packets as the packet where the header of an audio frame is located, framing each packet where the header of an audio frame is located and the RTP packets carrying audio data with removal of the header before the next packet where the header of an audio frame is located into a frame in sequence.

Step 206: generating a file, and writing the framed data frames into the generated file.

Step 207: after transmission is interrupted, the client terminal storing the timestamp of the data frame that is written into the file lastly, and discarding the cached RTP packets.

The streaming media data are written into the file in sequence through steps 205 and 206, and they are not written until a frame is made, ensuring that each frame of data that is written into the file is complete; step 207 ensures that when transmission is interrupted, the first frame of data stored in the file is also a plurality of complete and continuous data frames of I frame, which ensures normal display and a clear and continuous picture can be shown without any problem such as mosaic or picture interruption, therefore, the file can still be normally displayed after transmission is interrupted.

Step 208: the client terminal initiating a streaming media session establishment request by sending to the streaming media server a RTSP Describe request carrying the URL address of the interrupted streaming media source file.

Step 209: after a streaming media session is established, the client terminal writing the stored timestamp into the request time field added in the RTSP play as the starting time of resumed transmission, writing the ending time of the selected portion for downloading in the streaming media source file into the request time field as the ending time of resumed transmission, and sending the RTSP play to the streaming media server;

If transmission is not interrupted again, execute steps 211-213 until a transmission ending notification is received when this flow of downloading is over, or the transmission is interrupted again; if transmission is interrupted again, return to step 107 to resume transmission again and proceed with the current download task.

Step 210: the streaming media server receiving the RTSP play and analyzing the request time field of the RTSP play to obtain the timestamp and ending time stored by the client terminal, searching out the streaming media data corresponding to a period from the timestamp to the ending time, and transmitting the streaming media data corresponding to the period, i.e., the streaming media data that need to resume to be transmitted, to the client terminal by carrying them with RTP packets.

Step 211: the client terminal receiving and caching the RTP packets carrying streaming media data transmitted from the streaming media server.

Step 212: the client terminal sorting and framing the cached RTP packets; the specific procedure for sorting and framing here are the same as described in step 205, and thus will not be described repeatedly.

Step 213: writing the framed data frames into the file generated before transmission is interrupted.

In steps 207-213, after transmission is interrupted, the timestamp of the data frame that is written into the file lastly is stored, the interruption point is searched according to the stored timestamp to determine the starting streaming media data that need to resume to be transmitted, and the streaming media data that need to resume to be transmitted is transmitted so that download of the streaming media source file can be completed by resuming transmission at the interruption point after transmission is interrupted.

In steps 201-213, after a streaming media session is established through signaling interaction between the client terminal and the streaming media server, the client terminal informs the streaming media server of the selected portion for downloading in the streaming media source file; the streaming media server transmits the streaming media data of the selected portion for downloading to the client terminal, and the client terminal caches, sorts, frames the streaming media data and writes them into a file. Since the entire flow of downloading does not use protocols such as FTP and HTTP, download of streaming media is achieved without servers except the streaming media server.

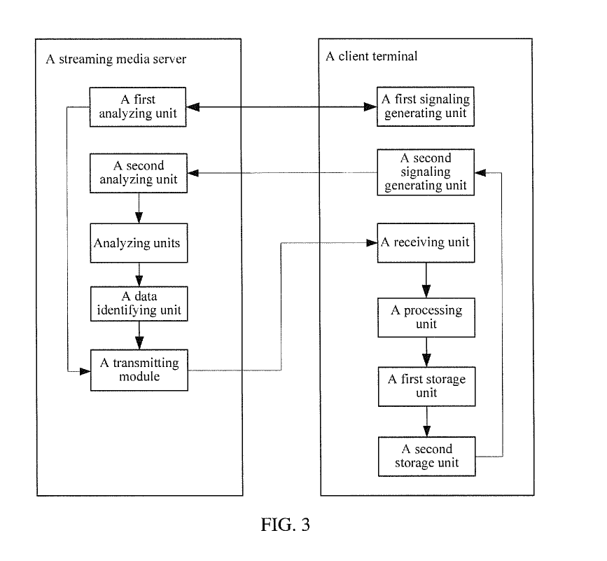

The structure of the system for downloading streaming media according to Example three of the present invention is as shown in FIG. 3, and the system comprises:

a streaming media server used for transmitting streaming media data carried with RTP packets through a streaming media session;

a client terminal used for receiving and caching the RTP packets; for sorting and framing the cached RTP packets; and for generating a file and writing the framed data frames into the generated file.

Wherein, the streaming media server comprises:

a first analyzing unit used to have signaling interaction with the client terminal to establish a streaming media session;

a transmitting module used to obtain streaming media data required by the client terminal, and transmit the obtained streaming media data to the client terminal by carrying them with RTP packets.

The client terminal further comprises:

a first signaling generating unit used to have signaling interaction with the streaming media server to establish a streaming media session;

a receiving unit used to receive and cache the RTP packets;

a processing unit used to sort and frame the cached RTP packets; and

a first storage unit used to generate a file and write framed data frames into the generated file.

The client terminal further comprises:

a second storage unit used to store a timestamp of a data frame that is written into the file lastly when transmission is interrupted; and

a second signaling generating unit used to generate and send a RTSP play command carrying the stored timestamp; and generate and send a RTSP play command carrying a starting time and an ending time of a selected portion for downloading in the streaming media source file.

The streaming media server further comprises:

a second analyzing unit used to analyze the RTSP play command carrying the stored timestamp to obtain the stored timestamp; and analyze the RTSP play command carrying a starting time and an ending time of a selected portion for downloading in the streaming media source file to obtain the starting time and ending time of a selected portion for downloading in the streaming media source file; and

a data identifying unit used to determine streaming media data required by the client terminal to be transmitted according to the stored timestamp; and determine streaming media data required by the client terminal to be transmitted according to the starting time and ending time of a selected portion for downloading in the streaming media source file.

The data that can be downloaded using the method and system of the present invention are not limited to RTP/RTCP/User Datagram Protocol (UDP) type of data, and applies to a plurality of transmission environments such as wire and wireless networks.

What are described above are only preferred examples of the present invention and are not intended to limit the protection scope of the present invention.

### INDUSTRIAL APPLICABILITY

With the streaming media server, client terminal and method and system for downloading streaming media provided by the present invention, streaming media data are written into the file in sequence and they are not written until a frame is made, ensuring that each frame of data that is written into the file is complete and that the streaming media data that have already been downloaded can be displayed, i.e., the picture is continuous and clear, problems such as mosaic or picture interruption will not occur when downloading is interrupted. The present invention also has the following advantages and features:

1) the present invention can achieve download of a streaming media source file only through a streaming media server without any server such as a FTP server or a HTTP server;

2) in the present invention, the timestamp of the data frame that is written into the file lastly is stored after transmission is interrupted, and the streaming media data that need to resume to be transmitted are determined according to the stored timestamp and resume to be transmitted so that download of the streaming media source file can be completed by resuming transmission at the interruption point after transmission is interrupted;

3) in the present invention, the streaming media server is informed of the part of the streaming media source file in which a user is interested by setting a request time field so that the user can freely download the streaming media data of the part in the streaming media source file in which he is interested.

1. A method for downloading streaming media, comprising:
receiving and caching transmitted streaming media data of a streaming media source file carried by real-time transport protocol (RTP) packets through a streaming media session;
sorting and framing the cached RTP packets; and
generating a file, writing framed data frames into the generated file.

2. The method according to claim 1, further comprising:
storing a timestamp of a data frame that is written into the file lastly when transmission is interrupted, and discarding the cached RTP packets that have not been framed into data frames;
initiating a streaming media session establishment request by sending to a streaming media server a real-time streaming protocol describe (RTSP Describe) request carrying a URL address of a streaming media source file whose transmission is interrupted;
sending to the streaming media server a RTSP play command carrying the stored timestamp;
receiving and caching the streaming media data of the streaming media source file carried by RTP packets through the streaming media session, wherein said streaming media data are streaming media data that need to resume to be transmitted determined by the stored timestamp;
sorting and framing the cached RTP packets; and
once a data frame is framed, writing the frame of data into the file generated before transmission is interrupted.

3. The method according to claim 1, wherein the step of sorting and framing the cached RTP packets comprises:
a. sorting the cached RTP packets;
b. searching out a first RTP packet carrying I-frame data from a sequence of RTP packets obtained by sorting; discarding RTP packets before the first RTP packet carrying I-frame data searched out in the sequence, and differentiating RTP packets carrying audio data from those carrying video data according to a PID field of a RTP packet starting from the first RTP packet carrying I-frame data that is searched out, and framing the RTP packets carrying audio and video data respectively.

4. The method according to claim 1, wherein the step of receiving and caching transmitted streaming media data of a streaming media source file carried by RTP packets through a streaming media session comprises:
establishing the streaming media session;
sending to the streaming media server a RTSP play command carrying a starting time and an ending time of a selected portion for downloading in the streaming media source file; and
receiving and caching the RTP packets carrying the streaming media data transmitted by the streaming media server; wherein said streaming media data are streaming media data in the streaming media source file corresponding to a period from the starting time to the ending time.

5. The method according to claim 2, wherein the step of said receiving and caching streaming media data of a streaming media source file carried by RTP packets through a streaming media session comprises:
establishing the streaming media session;
sending to the streaming media server a RTSP play command carrying a starting time and an ending time of a selected portion for downloading in the streaming media source file; and
receiving and caching the RTP packets carrying the streaming media data transmitted by the streaming media server; wherein said streaming media data are streaming media data in the streaming media source file corresponding to a period from the starting time to the ending time.

6. The method according to claim 5, wherein the streaming media data that need to resume to be transmitted can be streaming media data in the streaming media source file corresponding to a period from the stored timestamp to the ending time.

7. A client terminal configured to receive and cache real-time transport protocol (RTP) packets carrying streaming media data transmitted by a streaming media server through a streaming media session; sort and frame the cached RTP packets; and generate a file and write framed data frames into the generated file; thereby achieving download of streaming media.

8. The client terminal according to claim 7, comprising:
a first signaling generating unit configured to have signaling interaction with the streaming media server to establish the streaming media session;
a receiving unit configured to receive and cache the RTP packets;
a processing unit configured to sort and frame the cached RTP packets; and
a first storage unit configured to generate the file and write the framed data frames into the generated file.

9. The client terminal according to claim 8, further comprising:
a second storage unit configured to store a timestamp of a data frame that is written into the file lastly when transmission is interrupted; and
a second signaling generating unit configured to generate and send a RTSP play command carrying the stored timestamp; and generate and send a RTSP play command carrying a starting time and an ending time of a selected portion for downloading in a streaming media source file.

10. A streaming media server configured to transmit to a client terminal streaming media data carried by real-time transport protocol (RTP) packets through a streaming media session;
thereby the client terminal can receive and cache the RTP packets, sort and frame the cached RTP packets, generate a file and write the framed data frames into the generated file to achieve download of streaming media.

11. The streaming media server according to claim 10, comprising:
a first analyzing unit configured to have signaling interaction with the client terminal to establish a streaming media session; and
a transmitting module configured to obtain streaming media data required by the client terminal, transmit the obtained streaming media data to the client terminal by carrying said data with RTP packets.

12. The streaming media server according to claim 11, further comprising:
a second analyzing unit configured to analyze a RTSP play command carrying a stored timestamp to obtain the stored timestamp; and analyze the RTSP play command carrying a starting time and an ending time of a selected portion for downloading in a streaming media source file to obtain the starting time and the ending time of a selected portion for downloading in the streaming media source file; and
a data identifying unit configured to determine streaming media data required by the client terminal to be transmitted according to the stored timestamp; and determine streaming media data required by the client terminal to be transmitted according to the starting time and ending time of a selected portion for downloading in the streaming media source file.

13. A system for downloading streaming media, comprising a client terminal and a streaming media server, wherein:
the client terminal is configured to receive and cache real-time transport protocol (RTP) packets carrying streaming media data transmitted by a streaming media server through a streaming media session; sort and frame the cached RTP packets; and generate a file and write framed data frames into the generated file;
the streaming media server is configured to transmit to the client terminal streaming media data carried by the RTP packets through the streaming media session;
thereby achieving download of streaming media.

14. The system according to claim 13, wherein the client terminal comprises:
a first signaling generating unit configured to have signaling interaction with the streaming media server to establish the streaming media session;
a receiving unit configured to receive and cache the RTP packets;
a processing unit configured to sort and frame the cached RTP packets; and
a first storage unit configured to generate the file and write the framed data frames into the generated file.

15. The system according to claim 14, wherein the client terminal further comprises:
a second storage unit configured to store a timestamp of a data frame that is written into the file lastly when transmission is interrupted; and
a second signaling generating unit configured to generate and send a RTSP play command carrying a stored timestamp; and generate and send a RTSP play command carrying a starting time and an ending time of a selected portion for downloading in a streaming media source file.

16. The system according to claim 13, wherein the streaming media server comprises:
a first analyzing unit configured to have signaling interaction with the client terminal to establish a streaming media session; and
a transmitting module configured to obtain streaming media data required by the client terminal, transmit the obtained streaming media data to the client terminal by carrying said data with RTP packets.

17. The system according to claim 16, wherein the streaming media server further comprises:
a second analyzing unit configured to analyze the RTSP play command carrying a stored timestamp to obtain the stored timestamp; and analyze the RTSP play command carrying a starting time and an ending time of a selected portion for downloading in a streaming media source file to obtain the starting time and ending time of a selected portion for downloading in the streaming media source file; and
a data identifying unit configured to determine streaming media data required by the client terminal to be transmitted according to the stored timestamp; and determine streaming media data required by the client terminal to be transmitted according to the starting time and ending time of a selected portion for downloading in the streaming media source file.

18. The system according to claim 14, wherein the streaming media server comprises:
a first analyzing unit configured to have signaling interaction with the client terminal to establish a streaming media session; and
a transmitting module configured to obtain streaming media data required by the client terminal, transmit the obtained streaming media data to the client terminal by carrying said data with RTP packets.

19. The system according to claim 15, wherein the streaming media server comprises:
a first analyzing unit configured to have signaling interaction with the client terminal to establish a streaming media session; and
a transmitting module configured to obtain streaming media data required by the client terminal, transmit the obtained streaming media data to the client terminal by carrying said data with RTP packets.

20. The system according to claim 18, wherein the streaming media server further comprises:
a second analyzing unit configured to analyze the RTSP play command carrying a stored timestamp to obtain the stored timestamp; and analyze the RTSP play command carrying a starting time and an ending time of a selected portion for downloading in a streaming media source file to obtain the starting time and the ending time of a selected portion for downloading in the streaming media source file; and
a data identifying unit configured to determine streaming media data required by the client terminal to be transmitted according to the stored timestamp; and determine streaming media data required by the client terminal to be transmitted according to the starting time and the ending time of a selected portion for downloading in the streaming media source file.
